(19) United States
(12) Patent Application Publication
(10) Pub. No.: US 2026/0116078 A1
(43) Pub. Date: Apr. 30, 2026

(54) PRINTING APPARATUS, PRINTING SYSTEM, AND CONTROL METHOD

(71) Applicant: CANON KABUSHIKI KAISHA, Tokyo (JP)

(72) Inventor: Masafumi Inagaki, Kanagawa (JP)

(21) Appl. No.: 19/369,658

(22) Filed: Oct. 27, 2025

(30) Foreign Application Priority Data
Oct. 31, 2024 (JP) 2024-191968

(51) Int. Cl. B41J 2/175; B41J 3/46; B41J 29/393

(52) U.S. Cl. CPC B41J 2/17566; B41J 2/1752; B41J 3/46; B41J 29/393; B41J 2002/17589

(57) ABSTRACT

A printing apparatus includes: an attachment unit for attaching a liquid pack storing a liquid; a liquid tank configured to store a liquid supplied from the liquid pack attached in the attachment unit; a print head configured to eject the liquid onto a print medium, using the liquid supplied from the liquid tank; a first obtaining unit configured to obtain a remaining amount of liquid in the liquid tank; a second obtaining unit configured to obtain a remaining amount of liquid in the liquid pack; a notification unit configured to notify information about replacement of the liquid pack; and a control unit configured to perform control based on a received print job. Upon receipt of a print job, the control unit derives a period during which replacement of the liquid pack is recommended, and causes the notification unit to notify the period.

### BACKGROUND

### Field of the Technology

The present disclosure relates to a printing apparatus, a printing system, and a control method.

### Description of the Related Art

Japanese Patent Laid-Open No. 2023-081653 discloses a printing apparatus that, before executing a print job, obtains the remaining amount of ink stored in an ink tank and the use amount of ink required to execute the print job, and determines whether the print job can be completed.

In the printer of Japanese Patent Laid-Open No. 2023-081653, a warning mark is displayed next to an unprintable print image (print job) before starting printing. The printer of Japanese Patent Laid-Open No. 2023-081653 notifies a user of the unprintable print job before starting printing.

Some printing apparatuses have a detachable liquid pack that contains a liquid to be supplied to a liquid tank, separately from the liquid tank connected to a print head. With this type of printing apparatus, even if the liquid pack becomes empty, printing can be carried on as long as there is the liquid remaining in the liquid tank.

However, Japanese Patent Laid-Open No. 2023-081653 does not disclose a method for obtaining the remaining amount of ink in both the liquid pack and the liquid tank.

### SUMMARY

A printing apparatus includes: an attachment unit for attaching a liquid pack storing a liquid; a liquid tank configured to store a liquid supplied from the liquid pack attached in the attachment unit; a print head configured to eject the liquid onto a print medium, using the liquid supplied from the liquid tank; a first obtaining unit configured to obtain a remaining amount of liquid in the liquid tank; a second obtaining unit configured to obtain a remaining amount of liquid in the liquid pack; a notification unit configured to notify information about replacement of the liquid pack; and a control unit configured to perform control based on a received print job, wherein, upon receipt of a print job, the control unit derives a period during which replacement of the liquid pack is recommended, and causes the notification unit to notify the period.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a printing apparatus applicable to an embodiment.

FIG. 2 is a functional block diagram illustrating a control configuration of the printing apparatus applicable to the embodiment.

FIG. 3 is a diagram explaining a configuration of an ink tank and an ink pack.

FIG. 4 is a flowchart of print processing applicable to the embodiment.

FIG. 5 is a diagram illustrating an example of a first confirmation screen applicable to the embodiment.

FIG. 6 is a flowchart illustrating a subroutine of S406 applicable to the embodiment.

FIG. 7 is a diagram illustrating an example of a first notification screen applicable to the embodiment.

FIG. 8 is a diagram illustrating an example of a second notification screen applicable to the embodiment.

FIG. 9 is a diagram illustrating an example of a third notification screen applicable to the embodiment.

FIG. 10 is a diagram illustrating an example of a second confirmation screen applicable to the embodiment.

FIG. 11 is a diagram illustrating a subroutine of S406 applicable to an embodiment.

FIG. 12 is a diagram illustrating an example of a print interruption screen applicable to the embodiment.

FIG. 13 is a diagram illustrating an example of a fourth notification screen applicable to an embodiment.

FIG. 14 is a diagram illustrating an example of a printing system applicable to an embodiment.

FIG. 15A is a diagram illustrating an example of a device applicable to the embodiment.

FIG. 15B is a diagram illustrating another example of the device applicable to the embodiment.

### DESCRIPTION OF THE EMBODIMENTS

### First Embodiment

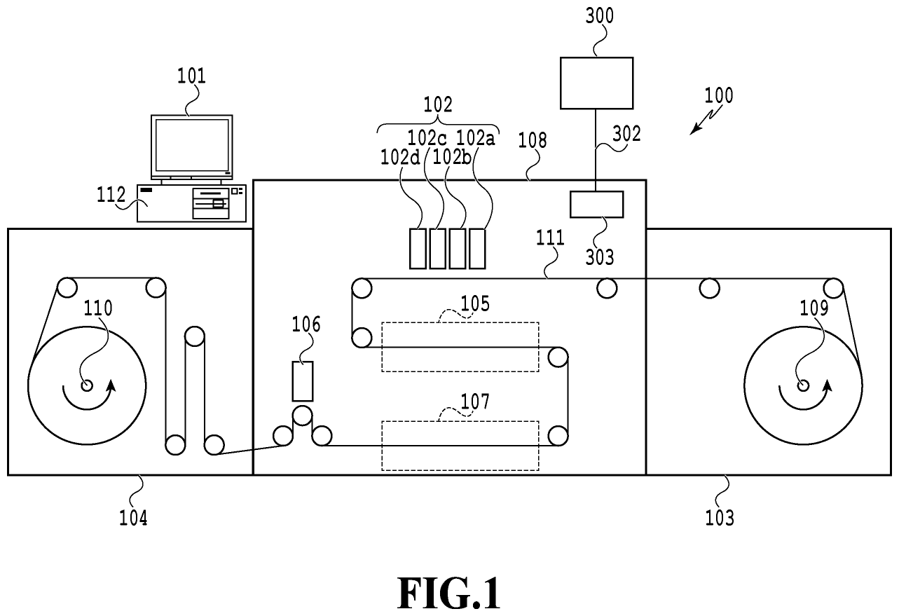

FIG. 1 is a diagram illustrating an example of a printing apparatus 100 applicable to the present embodiment.

The printing apparatus 100 illustrated in FIG. 1 forms an image on a print medium 111 that is capable of continuous printing. In the present embodiment, continuous paper (specifically, roll paper) is used as the print medium 111.

The printing apparatus 100 includes a feeding unit 103 configured to feed the print medium 111, a printing unit 108 configured to perform printing by ejecting a liquid (for example, ink) onto the print medium 111, and a winding unit 104 configured to wind the print medium 111. Hereinafter, the liquid is assumed to be ink.

The printing apparatus 100 includes a liquid tank for storing ink. In the present embodiment, an ink tank 303 is used as the liquid tank. A disposable liquid pack that contains ink is connected to the ink tank 303. In the present embodiment, an ink pack 300 is used as the liquid pack.

The printing unit 108 includes a dryer 105 for heating and drying the print medium 111, a cooler 107 for cooling the print medium 111, and a connection scanner 106 for reading the print medium 111. The printing apparatus 100 includes an operation panel 101 configured to notify a user of various information and to receive instructions inputted by the user, and a control PC 112 configured to perform overall control of the operation of the printing apparatus 100.

The printing unit 108 performs printing of a predetermined pattern and the like. The feeding unit 103 supplies the print medium 111 to the printing apparatus 100. The feeding unit 103 rotates the paper tube of the print medium 111 around a first rotation shaft 109, unwinds the print medium 111 wound around the paper tube, and conveys the print medium toward the printing unit 108 at a constant speed via a plurality of rollers (for example, conveyance rollers, feed rollers, and the like).

The winding unit 104 discharges the print medium 111 from the printing unit 108. The winding unit 104 rotates the print medium 111 conveyed from the printing unit 108 around a second rotation shaft 110 at a constant speed via a plurality of rollers, thereby winding the print medium 111 into a roll as a product. In the winding unit 104, the print medium 111 is wound around a paper tube of the second rotation shaft 110 and held in a roll. Before printing starts, the print medium 111 is passed from the feeding unit 103 to the winding unit 104 through a predetermined position in the apparatus.

The printing unit 108 includes a plurality of print heads 102. In the present embodiment, each of the plurality of print heads 102 ejects a different type of ink. For example, a first print head 102a, a second print head 102b, a third print head 102c, and a fourth print head 102d eject yellow, magenta, cyan, and black inks, respectively. Note that the types of inks are not limited to the above four types.

The first print head 102a, the second print head 102b, the third print head 102c, and the fourth print head 102d each eject the inks onto the print medium 111 to print an image. The print heads 102 are connected to the ink tank 303 and supplied with the inks from the ink tank 303. The print heads 102 have a number of nozzles provided therein. The inks are ejected from these nozzles onto the print medium 111 to print an image.

After the image is printed on the print medium 111, the print medium 111 is passed sequentially through the dryer 105, through the cooler 107, and below the connection scanner 106. After passing below the connection scanner 106, the print medium 111 is wound around the second rotation shaft 110.

In a case of performing printing, the print medium 111 is passed through the printing apparatus 100, and then a print job is submitted to the control PC 112. After the print job is submitted to the control PC 112, printing starts as a print execution button displayed on the operation panel 101 is pressed.

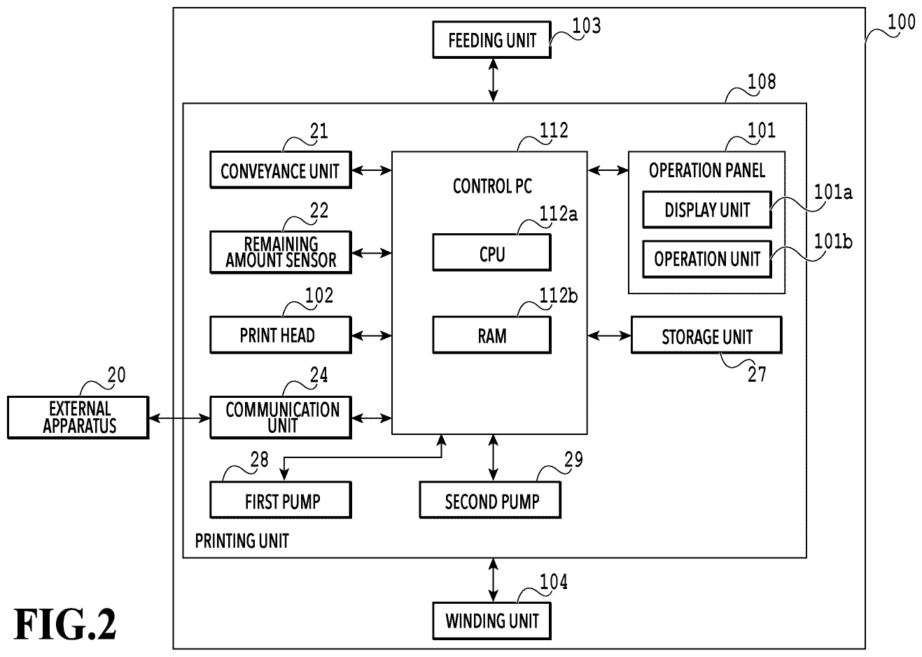

FIG. 2 is a functional block diagram illustrating a control configuration of the printing apparatus 100.

As illustrated in FIG. 2, the printing apparatus 100 includes a conveyance unit 21 for conveying the print medium 111, and a remaining amount sensor 22 for detecting a remaining amount of ink in the ink tank 303 (see FIG. 1 and the like) and the ink pack 300 of each color (see FIG. 1 and the like). The printing apparatus 100 also includes a communication unit 24 for sending and receiving various information to and from the outside, and a storage unit 27 for storing predetermined programs and the like. The printing apparatus 100 also includes a first pump 28 for supplying a liquid from the ink pack 300 to the ink tank 303. The printing apparatus 100 also includes a second pump 29 for supplying ink from the ink tank 303 to the print head 102.

The control PC 112 controls driving of the first pump 28 and the second pump 29. The control PC 112 includes a central processing unit (CPU) 112a and a random access memory (RAM) 112b.

The operation panel 101 includes a display unit 101a for displaying predetermined screens and an operation unit 101b for receiving user operations. The operation panel 101 is composed of, for example, a liquid crystal display with a touch panel. The display unit 101a displays various information on the liquid crystal display in accordance with a display control signal inputted from the control PC 112. The operation unit 101b includes various operation keys such as a numeric keypad and a start key. The operation unit 101b receives various input operations from the user and outputs operation signals to the CPU 112a. For example, the operation panel 101 is used to display the timing at which the ink pack 300 becomes empty before execution of a print job, and to execute the print job.

Information indicating the timing at which the ink pack 300 becomes empty and the timing suitable for replacing the ink pack 300 may be displayed in text or outputted as audio guidance.

The conveyance unit 21 is a mechanism for conveying the print medium 111 inside the printing apparatus 100. For example, the conveyance unit 21 conveys the print medium 111 conveyed from the feeding unit 103 to below the print head 102 using a plurality of rollers, and then conveys the print medium 111 that has passed below the print head 102 to the winding unit 104.

The communication unit 24 includes a communication control card (for example, a local area network (LAN) card or the like). The communication unit 24 sends and receives various data to and from an external apparatus 20 (for example, a personal computer) connected to a communication network (for example, a LAN, a wide area network (WAN), and the like).

In the control PC 112, the CPU 112a reads various programs, such as a system program and processing programs stored in the storage unit 27 and expands the programs into the RAM 112b to execute various processing according to the expanded programs. For example, the CPU 112a can perform print processing to execute a print job according to an instruction of the user.

The storage unit 27 is composed of, for example, a non-volatile semiconductor memory (so-called flash memory). The storage unit 27 may also be composed of a hard disk drive (HDD) or the like. The storage unit 27 stores various programs, including the system program and processing programs to be executed by the control PC 112, as well as various data required to execute these programs.

Next, description will be given of control in a case of performing print processing on the print medium 111 in the printing apparatus 100.

First, the user creates print job data and configures print setting for the print job in the external apparatus 20. The print job data and a job ticket containing print setting information of the print job are sent to the communication unit 24 via the communications network. The control PC 112 receives the print job data and job ticket sent from the external apparatus 20 via the communication unit 24.

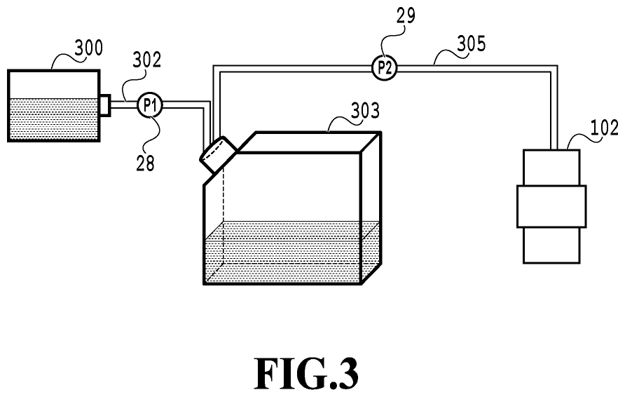

FIG. 3 is a diagram illustrating the configuration of the ink tank 303 and the ink pack 300.

As illustrated in FIG. 3, the ink pack 300 and the ink tank 303 are connected by a first tube 302. The ink tank 303 and the print head 102 are connected by a second tube 305. In a case where the remaining amount of ink in the ink tank 303 falls below a predetermined value, the first pump 28 is driven to supply ink from the ink pack 300 to the ink tank 303 through the first tube 302.

Upon execution of printing, the second pump 29 is driven to supply ink from the ink tank 303 to the print head 102 through the second tube 305.

In the present embodiment, the ink pack 300 is configured to be attachable/detachable to/from the first tube 302. For example, once the ink pack 300 is empty, the depleted ink pack 300 is removed, and a new ink pack 300 in an initial state containing a predetermined amount of ink is attached. Such a system of the ink pack 300 and the ink tank 303 is provided for each of the plurality of print heads 102.

In the present embodiment, the ink use amount and time required to execute all received print jobs are estimated before printing starts. The time required to execute a print job varies depending on a print mode, paper type, ink type (for example, whether or not white ink is included), and the like. In a case where the ink use amount exceeds the amount of ink stored, the timing at which the ink pack 300 becomes empty is displayed on the display unit 101a (see FIG. 2).

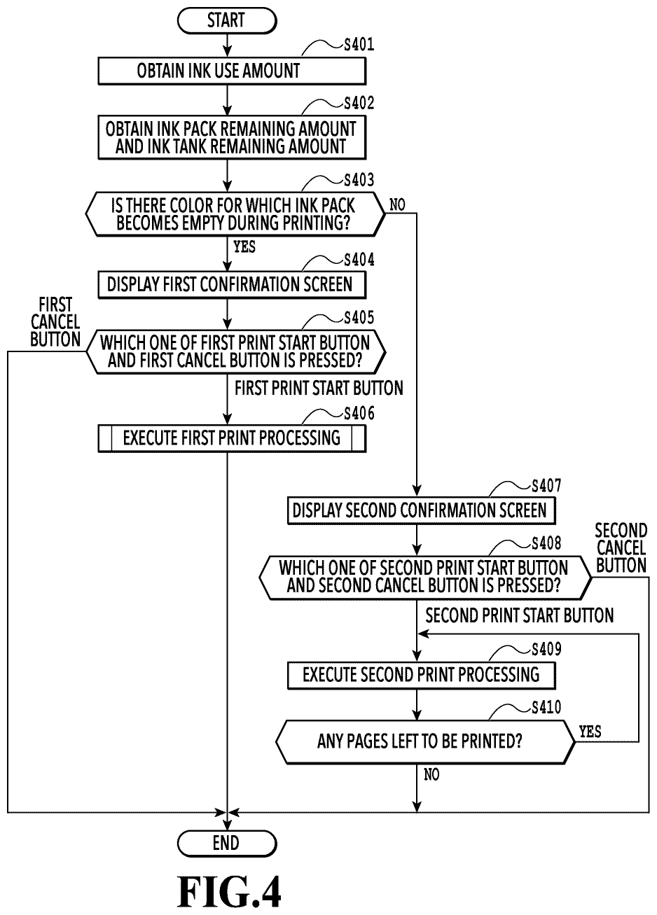

FIG. 4 is a flowchart of print processing applicable to the present embodiment.

A series of processing illustrated in this flowchart is performed by the CPU 112a illustrated in FIG. 2 expanding and executing a program code stored in the storage unit 27 into the RAM 112b. Note that “S” in the following description of each processing refers to a step in the flowchart. This flowchart is triggered and started by the CPU 112a obtaining a print job and saving print data included in the print job to the storage unit 27. In the present embodiment, it is assumed that image data to be printed is in PDF format. However, the format of the image data may also be TIF, JPEG or the like.

In S401, the CPU 112a obtains a value indicating an ink use amount required to execute the print job.

Specifically, the CPU 112a performs rasterization processing to convert the image data in PDF format into image data in raster file format. The CPU 112a then performs image processing on the created image data in raster file format to create a data file for each ink color that can be interpreted by the printing apparatus 100 (see FIG. 1 and the like). The CPU 112a checks the ink colors to be used to print all pages and saves ink color information, including information on the ink colors to be used for each page, in the storage unit 27. At this point, the created data file is broken down into data for each ink color, thus making it possible to check which ink colors are used for the inputted image data.

In this way, the value indicating the ink use amount required to execute the print job is obtained for each ink color.

In S402, the CPU 112a obtains a remaining amount value of the ink pack 300 (see FIG. 1 and the like) and a remaining amount value of the ink tank 303 (see FIG. 1 and the like) for each of the four colors described above. These remaining amount values may be detected by the remaining amount sensor 22, or may be derived based on the amount of ink previously ejected and the amount of ink supplied from the ink pack 300.

In the present embodiment, the remaining amount value of the ink pack 300 and the remaining amount value of the ink tank 303 are continuously obtained in real time.

In S403, the CPU 112a determines whether there is a color for which the ink pack 300 becomes empty during execution of the print job, based on the values obtained in S401 and S402. As described above, in the present embodiment, in a case where the remaining amount of the ink tank 303 falls below the predetermined value, a predetermined amount of ink is supplied from the ink pack 300 to the ink tank 303. Therefore, it is possible to determine whether the ink pack 300 becomes empty during printing, by obtaining the number of times ink is supplied from the ink pack 300 to the ink tank 303 and the amount of ink supplied per supply.

Whether the ink pack 300 becomes empty during printing can be determined using Formula (1) below.
Formula (1): ink tank remaining amount+supply amount per supply×number of supplies=ink use amount+ink tank remaining amount threshold

In a case where the ink pack remaining amount is less than the number of ink supplies×supply amount per supply, it can be determined that the ink pack becomes empty. The time required for the ink pack to become empty can be determined by calculating on what page the ink pack becomes empty during printing, based on the number of supplies required for the ink pack to become empty and the ink use amount per page, and then calculating the print time from the start of printing to the time point where this calculation is performed. Note that the ink use amount may include the amount of ink consumed for maintenance.

In a case where the ink pack 300 of at least one color becomes empty during the execution of a print job, the CPU 112a executes processing of S404. On the other hand, in a case where the ink pack 300 does not become empty during the execution of the print job, the CPU 112a executes processing of S407.

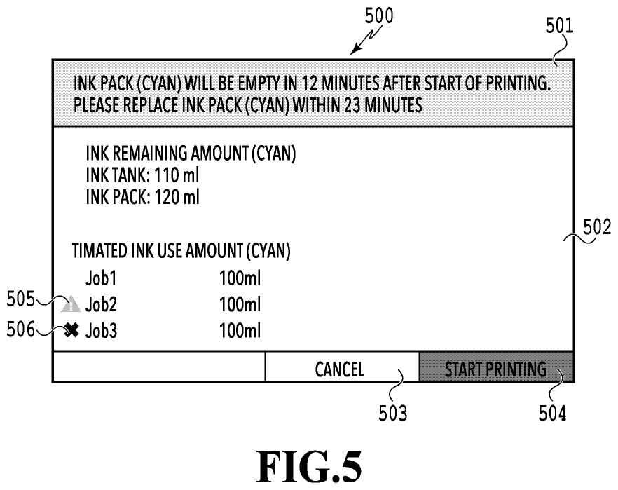

In S404, the CPU 112a displays a first confirmation screen 500 (see FIG. 5) on the display unit 101a (see FIG. 2) to confirm whether to execute the print processing.

FIG. 5 is a diagram illustrating an example of the first confirmation screen 500 applicable to the present embodiment.

As illustrated in FIG. 5, the first confirmation screen 500 includes a first confirmation area 501 for confirming the type of the ink pack 300 recommended for replacement and a time period suitable for replacing the ink pack 300. The first confirmation area 501 displays the start and end points of the time period suitable for replacing the ink pack 300.

In the example of FIG. 5, the first confirmation area 501 displays a message indicating that the cyan ink pack 300 becomes empty in 12 minutes after the start of printing. The first confirmation area 501 also displays a message indicating that the cyan ink pack 300 is recommended to be replaced in 23 minutes after the start of printing.

Therefore, the user who saw these messages can recognize that the print operation can be performed without interruption by replacing the cyan ink pack 300 in 12 to 23 minutes after the start of printing.

Note that the ink color, the time point where the ink pack 300 becomes empty, and the time point where the replacement of the ink pack 300 is recommended are not limited to the above-described example. For example, the replaceable period may be displayed in terms of time, such as “the ink pack (cyan) will be empty at 12:05. Please replace the ink pack (cyan) by 12:16”.

The first confirmation screen 500 also includes a second confirmation area 502 for confirming the current remaining amount in the ink tank 303, the current remaining amount in the ink pack 300, and the ink use amount required to execute the print job.

FIG. 5 illustrates an example where the current remaining amount in the cyan ink tank 303 is 110 ml, and the current remaining amount in the cyan ink pack 300 is 120 ml. The second confirmation area 502 displays the ink use amount required to execute the print job.

In a case where a plurality of print jobs are continuously executed, the second confirmation area 502 displays the ink use amount required for each of the print jobs. In the second confirmation area 502, a warning mark 505 indicating that the ink pack 300 becomes empty during execution of a print job, which is expected to be in progress at the start of the time period suitable for replacing the ink pack 300, is displayed next to the print job name of the print job. Furthermore, a cross mark 506 indicating that a print job, which is expected to be in progress at the end of the time period suitable for replacing the ink pack 300, cannot be completed is displayed next to the print job name of the print job.

FIG. 5 illustrates an example of a case where a first print job Job1, a second print job Job2, and a third print job Job3 are continuously performed in this order, and each print job uses 100 ml of cyan ink. In the example of FIG. 5, the warning mark 505 is displayed next to the job name of the second print job Job2, and the cross mark 506 is displayed next to the job name of the third print job Job3.

Therefore, by looking at the cross mark 506 displayed next to the job name of the third print job Job3, the user can recognize that the third print job Job3 cannot be completed unless the cyan ink pack 300 is replaced.

Although not illustrated in FIG. 5, a check mark may be displayed next to the job name of the first print job Job1, indicating that the first print job Job1 can be completed. By looking at the check mark, the user can recognize that the first print job Job1 can be completed even though the cyan ink pack 300 is not replaced.

The first confirmation screen 500 includes a first cancel button 503 for canceling the print processing before the start of the execution thereof, and a first print start button 504 for starting the print processing. This configuration makes it possible for the user to start printing while being aware of the start and end points of the time period suitable for replacing the ink pack 300.

Note that the various information displayed on the first confirmation screen 500 is not limited to the example illustrated in FIG. 5. For example, in the present embodiment, only the remaining amount of cyan ink, which is relatively low, is displayed. However, the remaining amounts of other colors of ink, which are relatively high, may also be displayed along with the remaining amount of cyan ink. Furthermore, the technology of the present disclosure is still applicable even in a case where there are two or more types of ink with relatively low remaining amount.

Although the first confirmation area 501 displays the start and end points of the time period suitable for replacing the ink pack 300, the advantageous effect of the technology of the present disclosure can be achieved as long as the start point of the time period suitable for replacing the ink pack 300 is displayed.

Although the first confirmation area 501 displays the start point of the time period suitable for replacing the ink pack 300, the start point of the time period suitable for replacing the ink pack 300 may be outputted as audio guidance from a speaker (not illustrated). As a matter of course, the start and end points of the time period may also be outputted as audio guidance from the speaker (not illustrated). This configuration can also achieve the advantageous effect of the technology of the present disclosure.

The description of the print processing will be carried on below by referring back to FIG. 4.

In S405, the CPU 112a determines whether the first print start button 504 (see FIG. 5) is pressed or the first cancel button 503 (see FIG. 5) is pressed. In a case where the first print start button 504 is pressed, processing of S406 is executed. On the other hand, in a case where the first cancel button 503 is pressed, the CPU 112a closes the first confirmation screen and ends this flowchart.

In S406, the CPU 112a executes first print processing to execute the received print job.

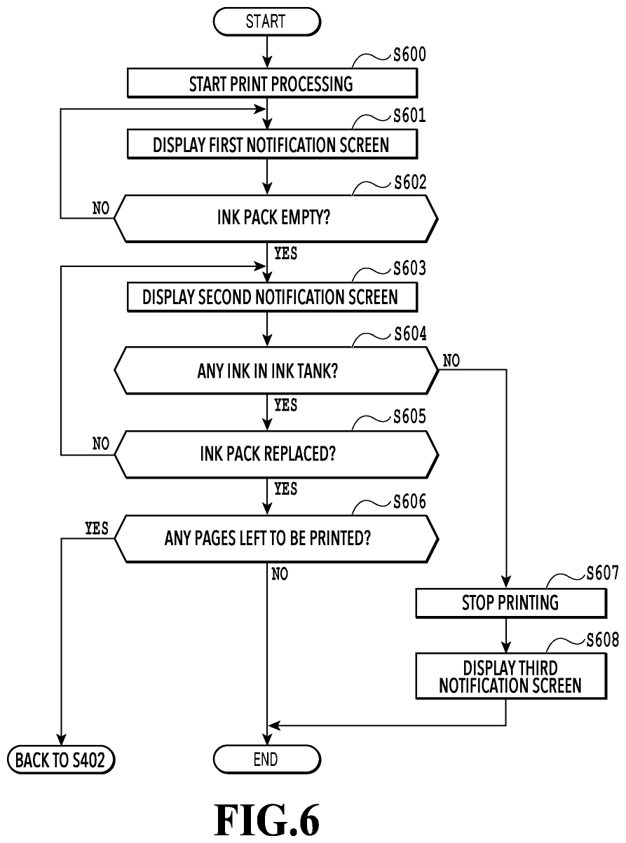

FIG. 6 is a flowchart illustrating a subroutine of S406.

In S600, the CPU 112a starts print processing for the received print job.

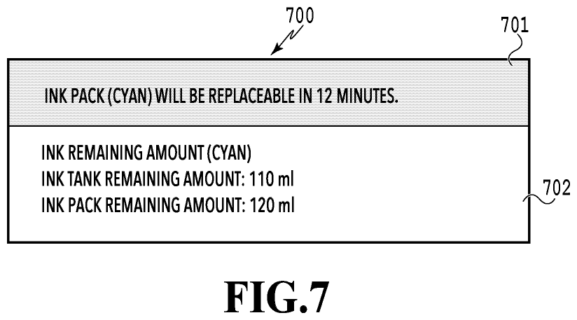

In S601, the CPU 112a displays a first notification screen 700 (see FIG. 7) on the display unit 101a to guide replacement of the ink pack 300.

FIG. 7 is a diagram illustrating an example of the first notification screen 700 applicable to the present embodiment.

As illustrated in FIG. 7, the first notification screen 700 includes a start point notification area 701 indicating, on a real-time basis, the start point of the time period suitable for replacing the ink pack 300.

The first notification screen 700 includes a first remaining amount notification area 702 notifying, on a real-time basis, the remaining amount of ink in the ink pack 300 (see FIG. 3 and the like) and the remaining amount of ink in the ink tank 303 (see FIG. 3 and the like).

In the present embodiment, the remaining amount of ink in the ink pack 300 and the remaining amount of ink in the ink tank 303 are obtained on a real-time basis by the CPU 112a and displayed in the first remaining amount notification area 702. The amount of ink supplied per minute from the ink pack 300 to the ink tank 303 is then obtained, and the remaining amount value of the ink pack 300 is divided by the value of the amount of ink supplied. The value obtained by this division is then added to the current time, thereby making it possible to calculate a time point at which the ink pack 300 becomes empty. In other words, the time point at which the ink pack 300 becomes empty can be determined.

In this way, the time point at which the ink pack 300 becomes empty is displayed on a real-time basis in the start point notification area 701.

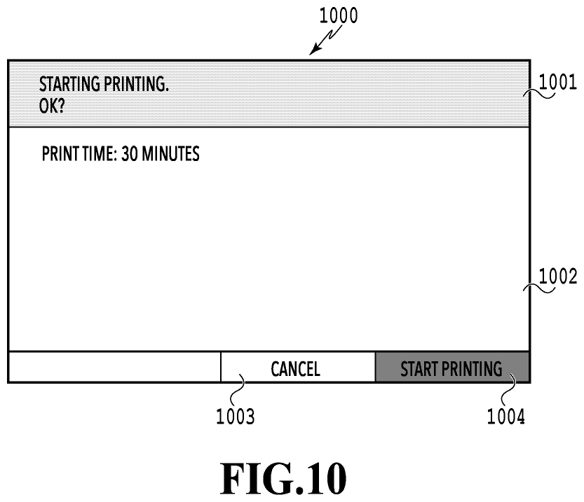

In the example of FIGS. 7, 10 ml of cyan ink is supplied per minute from the ink pack 300 to the ink tank 303. The remaining amount of cyan ink in the cyan ink pack 300 is 120 ml. The start point notification area 701 also displays a message indicating that the cyan ink pack 300 will be replaceable in 12 minutes.

Therefore, for example, in a case where the remaining amount of cyan ink in the cyan ink pack 300 reaches 110 ml one minute later, the start point notification area 701 displays a message indicating that the cyan ink pack 300 will be replaceable in 11 minutes. Also, in the first remaining amount notification area 702, the display of “ink pack remaining amount” changes from 120 ml to 110 ml. In this way, the first notification screen 700 displays the time point at which the ink pack 300 becomes replaceable and the remaining amount of ink in the ink pack 300, in a countdown manner. Alternatively, the configuration may be such that an “OK” button (not illustrated) may be displayed on the first notification screen 700, and the first notification screen 700 disappears as the “OK” button is pressed.

The description of the subroutine of S406 will be carried on below by referring back to FIG. 6.

In S602, the CPU 112a determines whether the ink pack 300 is empty based on the obtained remaining amount value of the ink pack 300. In a case where the ink pack 300 is empty, the CPU 112a executes processing of S603. In a case where there is ink remaining in the ink pack 300, the CPU 112a executes the processing of S601 again.

In S603, the CPU 112a displays a second notification screen 800 on the display unit 101a to prompt replacement of the ink pack 300.

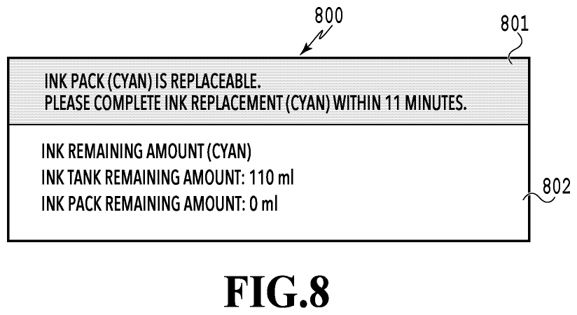

FIG. 8 is a diagram illustrating an example of the second notification screen 800 applicable to the present embodiment.

As illustrated in FIG. 8, the second notification screen 800 includes an end point notification area 801 notifying the end point of the time period suitable for replacing the ink pack 300 (see FIG. 3). The second notification screen 800 also includes a second remaining amount notification area 802 notifying the remaining amount of ink in the ink tank 303 (see FIG. 3) and that the ink pack 300 is empty.

In a case where the ink pack 300 becomes empty during execution of a print job, the second notification screen 800 displays a countdown of the time remaining until the ink tank 303 becomes empty from the current time point, as the remaining amount in the ink tank 303 decreases.

In the example of FIG. 8, the second remaining amount notification area 802 displays that the cyan ink pack 300 is empty and that the cyan ink tank 303 has 110 ml remaining. The example of FIG. 8 also illustrates a case where 10 ml of cyan ink is supplied and ejected per minute from the ink tank 303 to the third print head 102c (see FIG. 1). The end point notification area 801 displays a message prompting replacement of the cyan ink pack 300 within 11 minutes.

With this configuration, the user can recognize by looking at the end point notification area 801 that the user can carry on the print operation without interruption by replacing the cyan ink pack 300 within the next 11 minutes. Alternatively, the configuration may be such that an “OK” button (not illustrated) is displayed on the second notification screen 800, and the second notification screen 800 disappears as the “OK” button is pressed.

The description of the subroutine of S406 will be carried on below by referring back to FIG. 6.

In S604, the CPU 112a determines whether the ink tank 303 is empty based on the obtained remaining amount value of the ink tank 303. In a case where there is ink remaining in the ink tank 303, the CPU 112a executes processing ofS605. On the other hand, in a case where there is no ink remaining in the ink pack 300, the CPU 112a stands by with the second notification screen 800 (see FIG. 8) displayed.

In S605, the CPU 112a uses a known method to determine whether the ink pack 300 is replaced. In a case where the ink pack 300 is replaced, the CPU 112a executes processing of S606. On the other hand, in a case where the ink pack 300 is not replaced, the CPU 112a executes the processing of S603 again.

In S606, the CPU 112a uses a known method to determine whether there are any pages left to be printed. In a case where there are pages left to be printed, the CPU 112a executes the processing of S402 (see FIG. 4) again. In a case where there are no pages left to be printed, the CPU 112a ends the subroutine of S406 and ends the flowchart illustrated in FIG. 4.

In S607, the CPU 112a stops the print processing.

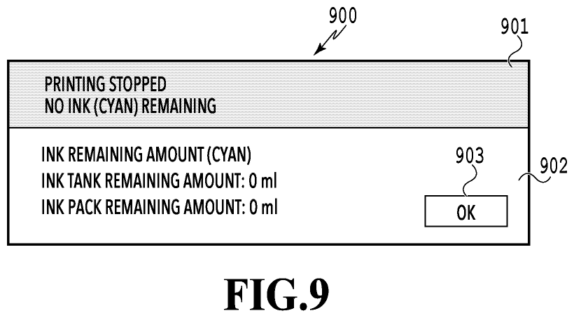

In S608, the CPU 112a displays a third notification screen 900 (see FIG. 9) on the display unit 101a to notify that the print processing is stopped.

FIG. 9 is a diagram illustrating an example of the third notification screen 900 applicable to the present embodiment.

As illustrated in FIG. 9, the third notification screen 900 includes a stop notification area 901 notifying that the print processing is stopped, and a third remaining amount notification area 902 notifying that the ink pack 300 and the ink tank 303 are empty. The third remaining amount notification area 902 includes an “OK” button 903 for allowing the user to recognize that the printing is stopped.

The user can recognize by looking at the message displayed in the stop notification area 901 and the remaining amounts displayed in the third remaining amount notification area 902 that the ink pack 300 and the ink tank 303 are empty and that the print processing is stopped before completed. The third notification screen 900 disappears as the user presses the “OK” button 903.

The description of the subroutine of S406 will be carried on below by referring back to FIG. 6.

After completion of S608, the CPU 112a ends the subroutine of S406 and ends the flowchart illustrated in FIG. 4.

The description of the print processing will be carried on below by referring back to FIG. 4.

In S407, the CPU 112a displays a second confirmation screen 1000 (see FIG. 10) on the display unit 101a to confirm whether it is possible to start the print processing.

FIG. 10 is a diagram illustrating an example of the second confirmation screen 1000 applicable to the present embodiment.

As illustrated in FIG. 10, the second confirmation screen 1000 includes a question display area 1001 displaying a question asking whether it is possible to execute the print processing, and a print time display area 1002 displaying the time required to execute all received print jobs. The second confirmation screen 1000 also includes a second cancel button 1003 for canceling printing, and a second print start button 1004 for starting printing.

In this way, in a case where the ink pack 300 does not become empty during execution of a print job, the first confirmation screen 500 (see FIG. 5) is not displayed. In other words, in a case where the ink pack 300 does not become empty during execution of a print job, the start point of the time period suitable for replacing the ink pack 300 is not displayed.

The description of the print processing will be carried on below by referring back to FIG. 4.

In S408, the CPU 112a determines whether the second print start button 1004 (see FIG. 10) is pressed or the second cancel button 1003 (see FIG. 10) is pressed. In a case where the second print start button 1004 is pressed, the CPU 112a executes processing of S409. In a case where the second cancel button 1003 is pressed, the CPU 112a ends this flowchart.

In S409, the CPU 112a executes second print processing to execute a received print job. Specifically, print processing is executed for one page of the received print job. However, in the second print processing, the time point at which the ink pack 300 can be replaced is not notified.

In S410, the CPU 112a uses a known method to determine whether there are any pages left to be printed. In a case where there are pages left to be printed, the CPU 112a executes the processing of S409 again. In a case where there are no pages left to be printed, the CPU 112a ends the processing of this flowchart.

The flowcharts in the present embodiment have been described above.

As described above, with the printing apparatus of the present embodiment, the remaining amount of ink in the ink pack and the remaining amount of ink in the ink tank are detected before the start of the print processing, and the amount of ink used per unit time is calculated. In a case where the ink pack becomes empty during the print processing, the start point of the time suitable for replacing the ink pack is displayed. Therefore, the user can recognize by looking at the display when to suitably start replacing the ink pack.

Therefore, the printing apparatus of the present embodiment can notify the time point suitable for replacing the liquid pack.

Furthermore, in a case where the end point of the time suitable for replacing the ink pack is displayed, the user can recognize, by looking at the display while the print operation in progress, by when the ink pack replacement should be completed.

With this configuration, even if the ink pack becomes empty during the print operation, the user can replace the ink pack before the ink tank becomes empty, and thus can carry on the print operation without interrupting the print operation.

Furthermore, in a case where the end point of the time suitable for replacing the ink pack is displayed, the user can know by when the user should return to the installation location of the printing apparatus to complete the ink pack replacement, even if the user has moved far from the printing apparatus. In other words, by knowing the latest by which the ink pack replacement should be started, the user can even perform another task in a different location.

### Second Embodiment

In the First Embodiment, in a case where the ink tank become empty while the ink pack is empty, the print processing is stopped. A Second Embodiment provides print processing that can be resumed by replacing an ink pack even if printing is interrupted since the ink pack and an ink tank are empty. In the following description, the same or corresponding components as those of the First Embodiment are denoted by the same reference numerals, and description thereof will be omitted. Instead, differences will be mainly described.

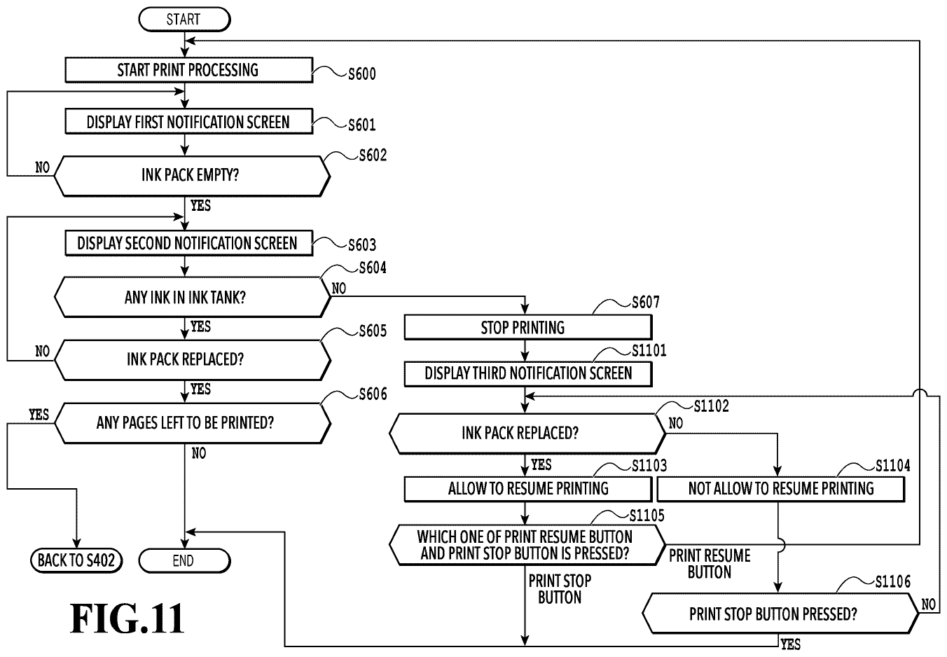

FIG. 11 is a flowchart illustrating a subroutine of S406 applicable to the present embodiment. In the example of FIG. 6, after the processing of S607, the processing of S608 is performed to display the third notification screen 900 (see FIG. 9).

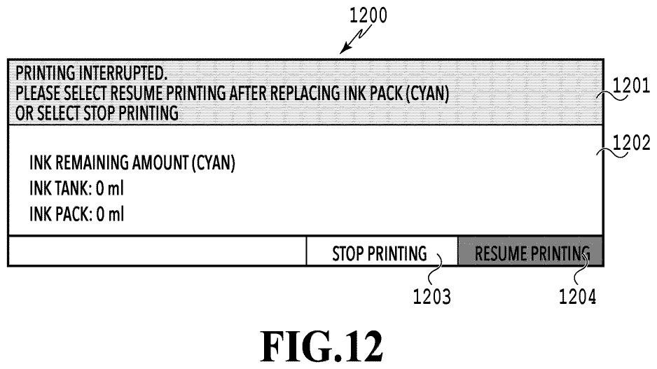

In the present embodiment, after the processing of S607, processing of S1101 is performed, and a print interruption screen 1200 (FIG. 12) including a button for resuming the interrupted print processing is displayed on the display unit 101a.

FIG. 12 is a diagram illustrating an example of the print interruption screen 1200 applicable to the present embodiment.

As illustrated in FIG. 12, the print interruption screen 1200 includes a first notification area 1201 including a message indicating that print processing is interrupted, and a second notification area 1202 notifying that the ink pack and the ink tank are empty. The print interruption screen 1200 also includes a print stop button 1203 for canceling printing and a print resume button 1204 for resuming the print processing.

In the present embodiment, the print processing is not allowed to be resumed until the ink pack 300 is replaced with a new ink pack 300 after the ink pack 300 becomes empty. For example, in a case where the ink pack 300 is empty, the print resume button 1204 is displayed in a grayed-out state. Therefore, the user cannot press the print resume button 1204 unless the ink pack 300 is replaced.

The description of the subroutine of S406 will be carried on below by referring back to FIG. 11.

In S1102, the CPU 112a uses a known method to determine whether the ink pack 300 is replaced. In a case where the ink pack 300 is replaced, the CPU 112a executes processing of S1103. In a case where the ink pack 300 is not replaced, the CPU 112a executes processing of S1104.

In S1103, the CPU 112a stands by in a state where pressing of the print resume button 1204 (see FIG. 12) is allowed. After completion of S1103, the CPU 112a executes processing of S1105.

In S1105, the CPU 112a determines whether the print resume button 1204 is pressed or the print stop button 1203 (see FIG. 12) is pressed. In a case where the print resume button 1204 is pressed, the processing of S600 is executed again. In a case where the print stop button 1203 is pressed, the subroutine of S406 in the present embodiment ends, and the flowchart of FIG. 4 ends.

In S1104, the CPU 112a stands by in a state where pressing of the print resume button 1204 is not allowed. After completion of S1104, the CPU 112a executes processing of S1106.

In S1106, the CPU 112a determines whether the print stop button 1203 is pressed. In a case where the print stop button 1203 is pressed, the subroutine of S406 in the present embodiment ends, and the flowchart of FIG. 4 ends. In a case where the print stop button 1203 is not pressed, the processing of S1102 is executed again.

As described above, with the printing apparatus of the present embodiment, the print processing can be resumed by replacing the ink pack, even if the ink pack and the ink tank become empty, resulting in a state where printing is interrupted.

### Third Embodiment

In the following description, the same or corresponding components as those of the First and the Second Embodiment are denoted by the same reference numerals, and description thereof will be omitted. Instead, differences will be mainly described. The present embodiment provides a printing apparatus capable of notifying a time period suitable for replacing an ink pack along with the progress of print processing.

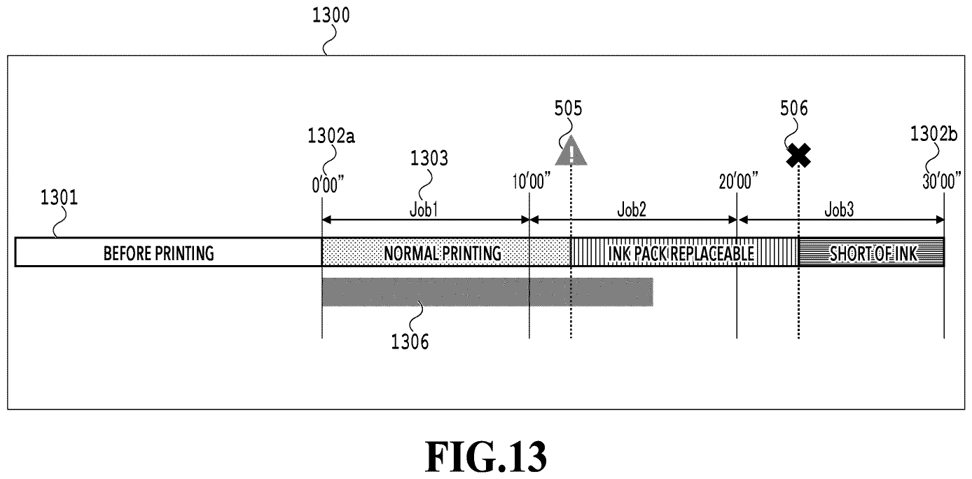

In the First and the Second Embodiment, the display unit 101a (see FIG. 2) displays the first notification screen 700 (see FIG. 7) and the second notification screen 800 (see FIG. 8) during the execution of a print job. A fourth notification screen 1300 (see FIG. 13) notifying a time period suitable for replacing an ink pack may be displayed during the execution of a print job.

FIG. 13 is a diagram illustrating an example of the fourth notification screen 1300 applicable to the present embodiment. In the present embodiment, the fourth notification screen 1300 is displayed on the display unit 101a during the execution of a print job.

As illustrated in FIG. 13, the fourth notification screen 1300 includes a schedule display section 1301 displaying a schedule for executing print jobs in a bar chart format, and a progress display section 1306 displaying the progress of print processing in a bar chart format.

The schedule display section 1301 includes a start time display section 1302a indicating the start time of the print processing, an end time display section 1302b indicating the end time of the print processing, and a print job name display section 1303 indicating the name of the print job to be executed. The schedule display section 1301 also displays a warning mark 505 and a cross mark 506.

In the example of FIG. 13, the ink pack 300 (see FIG. 1 and the like) becomes empty during execution of a second print job Job2, and the ink tank 303 (see FIG. 1 and the like) becomes empty during execution of a third print job Job3. The schedule display unit 1301 displays a message “ink pack replaceable” in a portion displaying the time period suitable for replacing the ink pack 300. Therefore, the user can recognize that the time period displayed as “ink pack replaceable” is the time period suitable for replacing the ink pack 300.

The progress display unit 1306 is located relatively close to the schedule display section 1301. As the print processing starts, a progress display bar in the progress display section 1306 extends in accordance with the progress of the print job.

With this configuration, the time period suitable for replacing the ink pack 300 is displayed as a bar, and the progress of the print job is displayed as a bar near the time period displayed as a bar. Therefore, the display unit 101a displays the time period suitable for replacing the ink pack 300 and the progress of the print job as bars close to each other, making it easier to visually recognize these two pieces of information together. The user can recognize whether the current time point is the “ink pack replaceable” time point, or a time point before the “ink pack replaceable” time point.

Although not illustrated in FIG. 13, at the time point before the “ink pack replaceable” time point, the progress display bar may display the time from the current time point to the start point of the time period suitable for replacing the ink pack 300. The remaining amount of ink in the ink pack 300 and the remaining amount of ink in the ink tank 303 may also be displayed, and the time remaining until the ink pack 300 and the ink tank 303 become empty may also be displayed.

### Fourth Embodiment

In the following description, the same or corresponding components as those of the First, the Second, and the Third Embodiment are denoted by the same reference numerals, and description thereof will be omitted. Instead, differences will be mainly described.

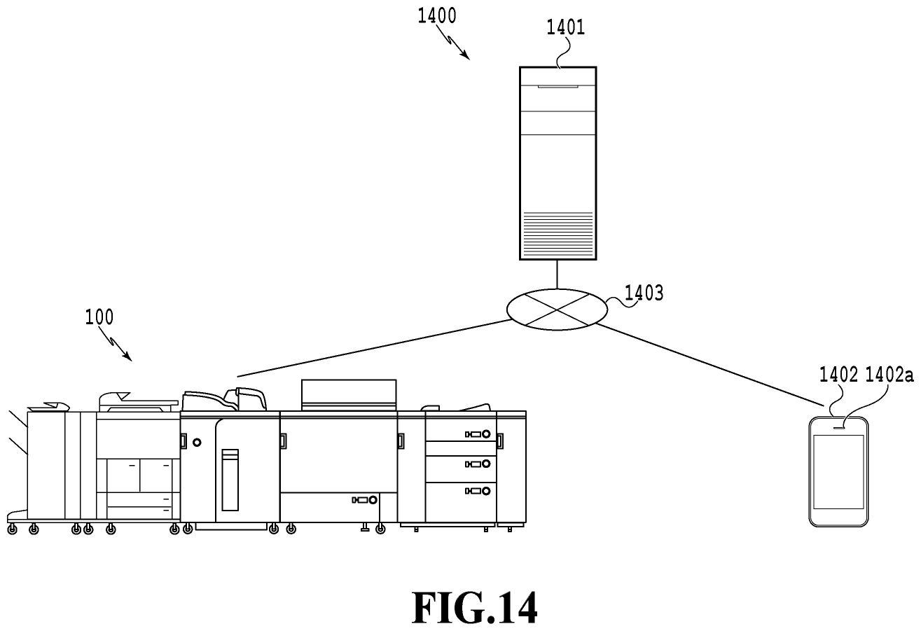

The present embodiment provides a printing system 1400 (see FIG. 14) capable of notifying a time period suitable for replacing an ink pack 300, even from a location far away from the printing apparatus 100 (see FIG. 1 and the like).

FIG. 14 is a diagram illustrating an example of the printing system 1400 applicable to the present embodiment.

As illustrated in FIG. 14, the printing system 1400 includes the printing apparatus 100, a server 1401, and a portable device 1402. The device 1402 may include a speaker 1402a capable of outputting a predetermined sound. Examples of the device 1402 include a smartphone, a personal computer, and the like. In the present embodiment, the device 1402 is assumed to be a smartphone. The printing apparatus 100, the server 1401, and the device 1402 are connected via a network 1403. The network 1403 may be wireless or wired.

In the present embodiment, period information including the time until the ink pack 300 becomes empty from the current time is sent from the printing apparatus 100 to the device 1402 via the server 1401. Once the device 1402 properly receives the period information, a device notification unit included in the device 1402 notifies the current time and the time from the current time to the start point of the time period suitable for replacing the ink pack 300.

For example, the communication unit 24 (see FIG. 2) of the printing apparatus 100 sends the device 1402 a message indicating the time until the ink pack 300 becomes empty from the current time. The device 1402 includes a receiving unit configured to receive the message and a display unit configured to display the message received by the receiving unit.

The information including the time period suitable for replacing the ink pack 300 may be sent to the device 1402 as a short message or by email. In the present embodiment, the information including the time period suitable for replacing the ink pack 300 is sent from the printing apparatus 100 to the device 1402 via the server 1401. However, this information may also be directly sent from the printing apparatus 100 to the device 1402.

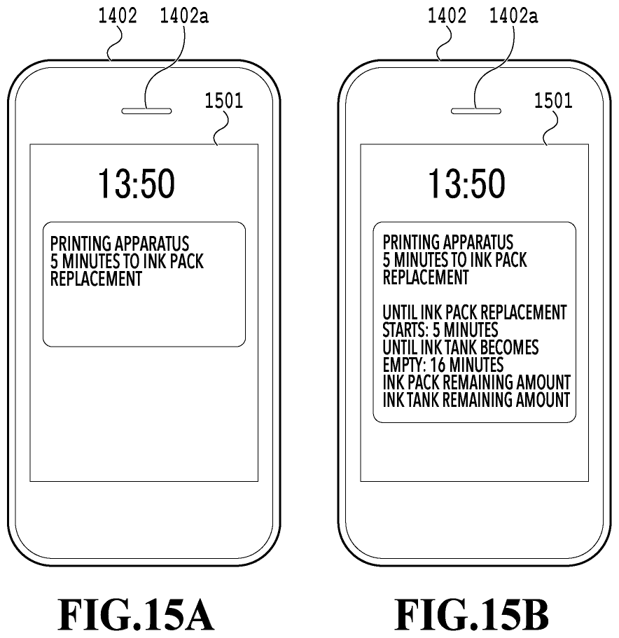

FIG. 15A is a diagram illustrating an example of the device 1402 applicable to the present embodiment.

As illustrated in FIG. 15A, the device 1402 has a message display section 1501 for displaying a message indicating the time remaining until the ink pack 300 (see FIG. 1 and the like) becomes empty from the current time. The content of this message may be outputted as audio guidance from the speaker 1402a.

As the device 1402 properly receives the above information, the message display section 1501 displays a simple message indicating the current time and the time from the current time to the start point of the time period suitable for replacing the ink pack 300. With this configuration, even if the user is located far away from the printing apparatus 100 (see FIG. 1 and the like), the user can know, by reading this simple message, the time from the current time to the start point of the time period suitable for replacing the ink pack 300.

Therefore, the printing system 1400 of the present embodiment (see FIG. 14) can notify the time period suitable for replacing the ink pack 300 even from a location far away from the printing apparatus 100.

FIG. 15B is a diagram illustrating another example of the device 1402 applicable to the present embodiment.

As illustrated in FIG. 15B, the message display section 1501 may display, in addition to a simple message, the time until the ink tank 303 (see FIG. 1 and the like) becomes empty from the current time point, the remaining amount of ink in the ink pack 300 (see FIG. 1 and the like), and the remaining amount of ink in the ink tank 303. In other words, a detailed message including such information may be displayed in the message display section 1501.

With this configuration, even if the user is located far away from the printing apparatus 100 (see FIG. 1 and the like), the user can recognize, upon reading the detailed message, by when the user should return to the installation location of the printing apparatus 100 to replace the ink pack 300.

In the example of FIG. 15B, the current time is 13:50, the time remaining until the ink tank 303 is empty is 5 minutes, and the time remaining until the ink tank 303 is empty is 16 minutes. Therefore, even if the user is located far away from the printing apparatus 100, the user can recognize that the user should return to the installation location of the printing apparatus 100 between 13:55 and 14:06 to replace the ink pack 300.

Thus, with this configuration, the user can recognize the time period suitable for replacing the ink pack 300.

### Other Embodiments

In the above embodiments, the start and end points of the time period suitable for replacing the ink pack are displayed. However, these start and end points may also be displayed as time of day. With this configuration, the advantageous effect of the technology of the present disclosure can be achieved.

In the First and the Second Embodiment, the start and end points of the time period suitable for replacing the ink pack are displayed. However, these start and end points may also be outputted as audio guidance, for example. With this configuration, the advantageous effect of the technology of the present disclosure can be achieved.

In the above embodiments, paper (specifically, roll paper) is used as the print medium. However, print media in a variety of materials and forms, such as cloth, optical disc label surface, plastic sheet, OHP sheet, and envelope, for example, can be used other than paper.

In the above embodiments, ink is used as the liquid, but the liquid that can be used for the technology of the present disclosure is not limited to ink. Various liquids can be used other than ink, including a treatment liquid and the like used for the purpose of improving ink fixability on a print medium, reducing gloss unevenness, and improving abrasion resistance.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-191968, filed Oct. 31, 2024, which is hereby incorporated by reference herein in its entirety.

The printing apparatus of the present disclosure can notify the time point suitable for replacing a liquid pack.

What is claimed is:

1. A printing apparatus comprising:
an attachment unit for attaching a liquid pack storing a liquid;
a liquid tank configured to store a liquid supplied from the liquid pack attached in the attachment unit;
a print head configured to eject the liquid onto a print medium, using the liquid supplied from the liquid tank;
a first obtaining unit configured to obtain a remaining amount of liquid in the liquid tank;
a second obtaining unit configured to obtain a remaining amount of liquid in the liquid pack;
a notification unit configured to notify information about replacement of the liquid pack; and
a control unit configured to perform control based on a received print job, wherein
upon receipt of a print job, the control unit derives a period during which replacement of the liquid pack is recommended, and causes the notification unit to notify the period.

2. The printing apparatus according to claim 1, wherein
upon receipt of a print job, the control unit obtains a use amount of liquid used by the print head for the print job, and derives the period based on the remaining amount of liquid in the liquid tank, the remaining amount of liquid in the liquid pack, and the use amount.

3. The printing apparatus according to claim 1, wherein
the control unit obtains an amount of liquid supplied per unit time from the liquid pack to the liquid tank during execution of printing for the print job, obtains a time point at which the liquid pack becomes empty based on the supplied amount and the remaining amount of liquid in the liquid pack, and causes the notification unit to notify the time point as a start point of the period during which replacement of the liquid pack is recommended.

4. The printing apparatus according to claim 3, wherein
in a case where the liquid pack becomes empty during execution of printing for the print job, the control unit causes the notification unit to notify the period during which replacement of the liquid pack is recommended, and
in a case where the liquid pack does not become empty during execution of printing for the print job, the control unit does not notify the period during which replacement of the liquid pack is recommended.

5. The printing apparatus according to claim 3, wherein
a plurality of attachment units and the liquid tanks are provided for each type of liquid, and
in a case where at least one of the plurality of liquid packs attached in the plurality of attachment units becomes empty during execution of the print job, the control unit causes the notification unit to notify the period during which replacement of the liquid pack is recommended, and
in a case where all of the plurality of liquid packs do not become empty during execution of the print job, the control unit does not notify the period during which replacement of the liquid pack is recommended.

6. The printing apparatus according to claim 3, wherein
the control unit obtains a time point at which both the liquid pack and the liquid tank become empty, based on the supplied amount and the remaining amount of liquid in the liquid tank, and causes the notification unit to notify the time point as an end point of the period during which replacement of the liquid pack is recommended.

7. The printing apparatus according to claim 1, wherein
in a case where the liquid pack does not become empty during execution of the print job, the control unit causes the notification unit to display a question asking whether it is possible to execute the print job and a print start button for executing the print job, before the start of the print job.

8. The printing apparatus according to claim 1, wherein
the control unit causes the notification unit to display a time required to execute the print job, along with the period during which replacement of the liquid pack is recommended.

9. The printing apparatus according to claim 1, wherein
the control unit causes the notification unit to display a countdown of a time remaining until the liquid pack becomes empty from a current time point, as the remaining amount in the liquid pack decreases.

10. The printing apparatus according to claim 1, wherein
the control unit causes the notification unit to display the remaining amount in the liquid tank and the remaining amount in the liquid pack.

11. The printing apparatus according to claim 10, wherein
in a case where the liquid pack becomes empty during execution of the print job, the control unit causes the notification unit to display a countdown of a time remaining until the liquid tank becomes empty from a current time point, as the remaining amount in the liquid tank decreases.

12. The printing apparatus according to claim 11, wherein
the control unit causes the notification unit to display the remaining amount in the liquid tank and the remaining amount in the liquid pack at the current time point.

13. The printing apparatus according to claim 12, wherein
in a case where the liquid tank becomes empty during execution of the print job, the control unit stops the execution of the print job and causes the notification unit to display a message notifying that the execution of the print job is stopped.

14. The printing apparatus according to claim 13, wherein
the control unit further causes the notification unit to display a print resume button for resuming the execution of the print job, and to display the print resume button in a state where the print resume button cannot be pressed if the liquid pack is not replaced.

15. The printing apparatus according to claim 14, wherein
the control unit causes the notification unit to display the print resume button in a state where the print resume button can be pressed if the liquid pack is replaced.

16. The printing apparatus according to claim 1, wherein
the control unit causes the notification unit to display the period in a bar chart format together with a schedule for executing the print job.

17. The printing apparatus according to claim 1, wherein
in a case where there are a plurality of print jobs, the control unit causes the notification unit to display the use amount of liquid required to execute each of the plurality of print jobs.

18. The printing apparatus according to claim 1, wherein
in a case where the liquid pack becomes empty during execution of the print job, the control unit causes the notification unit to display a first mark indicating that the liquid pack becomes empty next to a print job name of the print job.

19. The printing apparatus according to claim 18, wherein
in a case where the liquid tank becomes empty during execution of the print job, the control unit causes the notification unit to display a second mark indicating that the print job cannot be completed next to a print job name of the print job.

20. The printing apparatus according to claim 19, wherein
in a case where the liquid tank does not become empty during execution of the print job, the control unit causes the notification unit to display a third mark indicating that the print job can be completed next to a print job name of the print job.

21. A printing system comprising:
a printing apparatus including an attachment unit for attaching a liquid pack storing a liquid, a liquid tank configured to store a liquid supplied from the liquid pack attached in the attachment unit, a print head configured to eject the liquid onto a print medium, using the liquid supplied from the liquid tank, a first obtaining unit configured to obtain a remaining amount of liquid in the liquid tank, a second obtaining unit configured to obtain a remaining amount of liquid in the liquid pack, and a notification unit configured to notify information about replacement of the liquid pack; and
a portable device, wherein
the printing apparatus includes a control unit configured to derive a period during which replacement of the liquid pack is recommended, upon receipt of a print job, based on the received print job, and to send the period to the device,
the device includes
a receiving unit configured to receive the period, and
a device notification unit configured to notify the period.

22. The printing system according to claim 21, wherein
upon receipt of a print job, the control unit obtains a use amount of liquid used by the print head for the print job, and derives the period based on a remaining amount of liquid in the liquid tank, a remaining amount of liquid in the liquid pack, and the use amount.

23. A control method for a printing apparatus including
an attachment unit for attaching a liquid pack storing a liquid,
a liquid tank configured to store a liquid supplied from the liquid pack attached in the attachment unit,
a print head configured to eject the liquid onto a print medium, using the liquid supplied from the liquid tank, and
a notification unit configured to notify information about replacement of the liquid pack,
the method comprising:
obtaining a remaining amount of liquid in the liquid tank;
obtaining a remaining amount of liquid in the liquid pack; and
deriving a period during which replacement of the liquid pack is recommended, upon receipt of a print job, and causing the notification unit to notify the period.

24. The control method according to claim 23, wherein
upon receipt of a print job, a use amount of liquid used by the print head for the print job is obtained, and the period is derived based on the remaining amount of liquid in the liquid tank, the remaining amount of liquid in the liquid pack, and the use amount.
